(19) United States
(12) Patent Application Publication
(10) Pub. No.: US 2024/0352298 A1
(43) Pub. Date: Oct. 24, 2024

(54) HEAT TRANSFER COMPOSITIONS AND METHODS

(71) Applicant: HONEYWELL INTERNATIONAL INC., Charlotte, NC (US)

(72) Inventors: Ankit Sethi, Buffalo, NY (US); Samuel F. Yana Motta, East Amherst, NY (US); Gustavo Pottker, Amherst, NY (US); Mark W. Spatz, Buffalo, NY (US)

(73) Assignee: HONEYWELL INTERNATIONAL INC., Charlotte, NC (US)

(21) Appl. No.: 18/758,941

(22) Filed: Jun. 28, 2024

Related U.S. Application Data
(63) Continuation of application No. 17/040,467, filed on Sep. 22, 2020.
(60) Provisional application No. 62/644,158, filed on Mar. 16, 2018.

(51) Int. Cl. C09K 5/04; F25B 45/00

(52) U.S. Cl. CPC C09K 5/045; F25B 45/00; C09K 2205/122; C09K 2205/126; C09K 2205/22; C09K 2205/40

(57) ABSTRACT

Disclosed are methods of retrofitting heat transfer systems containing or designed to containing HFC-134a as the refrigerant comprising: removing at least a portion of said HFC-134a from said system; and introducing into said system a refrigerant comprising at least about 97.5% by weight of the following four components, with each compound being present in the following relative percentages:
(a) from 2% to about 7% by weight of difluoromethane (HFC-32);
(b) from 2% to about 7 by weight of pentafluoroethane (HFC-125);
(c) from about 35% to about 50% by weight of 1,1,1,2-tetrafluoroethane (HFC-134a); and
(d) from about 50% to about 55% by weight of trans-1,3,3,3-tetrafluoropropene (HFO-1234ze(E)).

### CROSS REFERENCE TO RELATED APPLICATION

This application is a continuation of U.S. patent application Ser. No. 17/040,467, filed on Sep. 22, 2020, which is a U.S. National Stage application of PCT Application No. PCT/US2019/22510, filed Mar. 15, 2019, which application is related to and claims the priority benefit of U.S. Provisional Application No. 62/644,158, filed Mar. 16, 2018. Each patent application listed above is incorporated herein by reference in its entirety.

### FIELD OF THE INVENTION

This invention relates to heat transfer compositions, methods and systems, with particular benefit in mobile air conditioning (also referred to herein as MAC) applications and in medium and low temperature refrigeration applications, and in particular aspects to refrigerant compositions for retrofit and/or replacement of the refrigerants such as HFC-134a in MAC applications and medium and low temperature refrigeration systems.

### BACKGROUND

During the course of the past several years, substantial effort has been devoted to developing more environmentally friendly alternatives to materials which had previously been frequently used for refrigeration and air conditioning purposes. For a long period of time the main refrigerant used for mobile air conditioning (MAC) systems had been HFC-134a. Although HFC-134a possesses many properties that make it attractive for use in MAC systems, it has a relatively high global warming potential (GWP) of about 1430 (100 years).

A similar problem has also existed, for example in connection with refrigeration systems known as “low temperature refrigeration systems,” which are particularly important to the food manufacture, distribution and retail industries in that they play a vital role in ensuring that food which reaches the consumer is both fresh and fit to eat. In such low temperature refrigeration systems, a commonly used refrigerant liquid has been HFC-404A (the combination of HFC-125:HFC-143a:HFC134a in an approximate 44:52:4 weight ratio is referred to in the art as HFC-404A or R-404A). R-404A has an estimated high Global Warming Potential (GWP) of 3922.

The fluorinated olefin HFO-1234yf has emerged after much research and development effort by the assignee of the present invention as the material of choice to replace HFC-134a in MAC systems. The emergence of HFO-1234yf as the next-generation material of choice for MAC systems is due primarily to its exceptional ability to provide a combination of difficult to achieve properties, such as excellent heat transfer characteristics, low toxicity, low flammability, and chemical stability, among other properties. Furthermore, HFO-1234yf is capable of providing this combination of properties with little or no need to be blended with other materials.

Despite the exceptional and extraordinary success of HFO-1234yf as the next generation refrigerant for many applications, including particularly MAC systems, the present inventors have come to appreciate that the need for the development of other materials which can be used to replace HFC-134a, preferably with little or no system modifications or adjustments, and which at the same time are non-flammable. Applicants have particularly come to recognize the need for the development of refrigerants which can be used to replace or retrofit HFC-134a systems, including particularly MAC systems, low temperature systems and medium temperature systems which contain HFC-134a as the refrigerant, without changing the expansion device used in the system.

Prior to and subsequent to the development of HFO-1234yf, much of the effort directed toward next-generation refrigerants was focused on the development of heat transfer compositions comprised of a blend or mixture of two or more components. However, many of these efforts have thus far been generally less than fully successful because of a failure to fully realize one or more of the myriad of properties required for a successful next generation refrigerant.

The fluorinated olefin 1,3,3,3-tetrafluoropropene (HFO-1234ze) has also been identified in an application assigned to the assignee of the present invention as a next generation refrigerant due to its advantageous combination of properties. See, for example, WO 2009/089511. While this application discloses that HFO-1234ze is very attractive as a refrigerant in many applications, it also reveals that it has a substantially lower capacity relative to HFC-134a than does HFO-1234yf in certain air conditioning applications when each is used as the sole refrigerant.

Blends comprising such fluorinated olefins (e.g. 1234ze or 1234yf) have been suggested for use in a wide variety of applications, including heat transfer compositions. However, the specific combination of components in the particular concentration ranges required by the present invention are not disclosed. Applicants have found that unexpected yet highly beneficial advantages can be achieved by careful selection of materials within a specific concentration range for forming a heat transfer composition blend which is at once capable of achieving highly desirable heat transfer properties for use in those applications in which HFC-134a has previously been used, including in MAC, low temperature and medium temperature applications, and particularly as a drop-in or near-drop in, and/or or as a retrofit, refrigerant for HFC-134a in such applications. Applicants have found that the blends of components as disclosed herein and in the amounts disclosed herein provide extraordinarily beneficial heat transfer properties in such applications while at the same time providing excellent environmental properties and desirably nonhazardous compositions from the standpoint of flammability.

Applicants have thus come to appreciate a need for compositions, and particularly heat transfer compositions, that are highly advantageous in heating and cooling systems and methods, particularly vapor compression heating and cooling systems, and even more particularly in MAC, or low temperature refrigerant systems, or medium temperature refrigeration systems, including particularly such systems which are used with and/or have been designed for use with HFC-134a.

### BRIEF DESCRIPTION OF THE DRAWING

FIG. 1 is a plot of data showing refrigeration performance as a function of the percentage of R-32/R-125 in the refrigerant according to Example 2.

FIG. 2 is a plot of data showing refrigeration performance as a function of the percentage of R-32/R-125 in the refrigerant according to Example 3.

### SUMMARY

Applicants have found that heat transfer compositions having highly desirable heat transfer and environmental properties can be produced which also have an unexpectedly advantageous level of safety or non-hazardousness from the standpoint of flammability/combustion impact and at the same time are able to perform as drop-in or near-drop in, and/or or as a retrofit, refrigerant for HFC-134a in such applications in MAC, or low temperature refrigerant systems, or medium temperature refrigeration systems. More specifically, applicants have found that great but unexpected advantages can be achieved by the use of compositions comprising HFO-1234ze, HFC-32, HFC-125 and HFC-134a in the relative concentration ranges disclosed herein in MAC applications, or low temperature refrigeration applications or in medium temperature refrigeration applications, in drop-in or near drop-in replacements and in drop-in or near drop-in retrofit methods for such applications.

As the term is used herein, “drop-in” in connection with replacement and retrofit methods means that the refrigerant of the present invention, including each of refrigerants 1-15, is used in the system without changing any of the condenser, the evaporator or the expansion device of the system. For the purposes of the present invention, the term “without changing” with respect to an identified item of equipment in the replacement or retrofit of a heat transfer system means that a new item of equipment is not needed for effective operation of the system, and accordingly such term would include within its scope a replacement or retrofit in which a new or refurbished item of the identified equipment could be installed in the system for purposes of regular or preventative maintenance.

Applicants have found that the above-noted needs, and other needs, can be satisfied by compositions, methods and systems of the present invention.

The present invention includes a multi-component refrigerant comprising at least 97% by weight of the following four components, with each compound being present in the following relative percentages: (a) from 2% to about 7% by weight of difluoromethane (HFC-32); (b) from 2% to about 7 by weight of pentafluoroethane (HFC-125); (c) from about 35% to about 50% by weight of 1,1,1,2-tetrafluoroethane (HFC-134a); and (d) from about 50% to about 55% by weight of trans-1,3,3,3-tetrafluoropropene (HFO-1234ze(E)). The refrigerant according to this paragraph is referred to herein for convenience as Refrigerant 1.

As used herein with respect to percentages based on a list of identified compounds or components, the term “relative percentage” means the percentage of the identified compound or component based on the total weight of the listed components.

As used herein with respect to weight percentages, the term “about” with respect to an amount of an identified component means the amount of the identified component can vary by an amount of ±1% by weight. The refrigerants and compositions of the invention include preferably amounts of an identified compound or component specified as being “about” wherein the amount is the identified amount ±0.5% by weight, more preferably ±0.3% by weight, and most preferably ±0.2% by weight.

The present invention includes a multi-component refrigerant comprising at least 99.5% by weight of the following four components, with each compound being present in the following relative percentages: (a) from 2% to less than 5% by weight of difluoromethane (HFC-32); (b) from 2% to less than 5% by weight of pentafluoroethane (HFC-125); (c) from about 35% to about 50% by weight of 1,1,1,2-tetrafluoroethane (HFC-134a); and (d) from greater than 50% to about 55% by weight of HFO-1234ze(E). The refrigerant according to this paragraph is referred to herein for convenience as Refrigerant 2.

The present The present invention includes refrigerants consisting of the following four compounds, with each compound being present in the following relative percentages: (a) from 2% to about 7% by weight of difluoromethane (HFC-32); (b) from 2% to about 7% by weight of pentafluoroethane (HFC-125); (c) from about 35% to about 50% by weight of 1,1,1,2-tetrafluoroethane (HFC-134a); and (d) from about 50% to about 55% by weight of HFO-1234ze(E). The refrigerant according to this paragraph is referred to herein for convenience as Refrigerant 35.

The present invention includes a multi-component refrigerant comprising at least 97% by weight of the following four components, with each compound being present in the following relative percentages: (a) from 2.5% to 6.5% by weight of difluoromethane (HFC-32); (b) from 2.5% to 6.5% by weight of pentafluoroethane (HFC-125); (c) from 36% to 40% by weight of 1,1,1,2-tetrafluoroethane (HFC-134a); and (d) from 51% to 55% by weight of HFO-1234ze(E). The refrigerant according to this paragraph is referred to herein for convenience as Refrigerant 6.

The present invention includes a multi-component refrigerant comprising at least 99.5% by weight of the following four components, with each compound being present in the following relative percentages: (a) from 2.5% to less than 5% by weight of difluoromethane (HFC-32); (b) from 2.5% to 6.5% by weight of pentafluoroethane (HFC-125); (c) from 36% to 40% by weight of 1,1,1,2-tetrafluoroethane (HFC-134a); and (d) from 51% to 55% by weight of HFO-1234ze(E). The refrigerant according to this paragraph is referred to herein for convenience as Refrigerant 7.

The present invention includes a multi-component refrigerant consisting of the following four components, with each compound being present in the following relative percentages: (a) from 2.5% to 6.5% by weight of difluoromethane (HFC-32); (b) from 2.5% to 6.5% by weight of pentafluoroethane (HFC-125); (c) from 36% to 40% by weight of 1,1,1,2-tetrafluoroethane (HFC-134a); and (d) from 51% to 55% by weight of HFO-1234ze(E). The refrigerant according to this paragraph is referred to herein for convenience as Refrigerant 6.

The present invention includes a multi-component refrigerant comprising at least 99.5% by weight of the following four components, with each compound being present in the following relative percentages: (a) from 3.5% to 5.5% by weight of difluoromethane (HFC-32); (b) from 3.5% to 5.5% by weight of pentafluoroethane (HFC-125); (c) from 37% to 39% by weight of 1,1,1,2-tetrafluoroethane (HFC-134a); and (d) from 52% to 54% by weight of HFO-1234ze(E). The refrigerant according to this paragraph is referred to herein for convenience as Refrigerant 7.

The present invention includes a multi-component refrigerant consisting of the following four components, with each compound being present in the following relative percentages: (a) from 3.5% to 5.5% by weight of difluoromethane (HFC-32); (b) from 3.5% to 5.5% by weight of pentafluoroethane (HFC-125); (c) from 37% to 39% by weight of 1,1,1,2-tetrafluoroethane (HFC-134a); and (d) from 52% to 54% by weight of HFO-1234ze(E). The refrigerant according to this paragraph is referred to herein for convenience as Refrigerant 8.

The present invention includes a multi-component refrigerant comprising at least 99.5% by weight of the following four components, with each compound being present in the following relative percentages: (a) 4.5%+/−0.5% by weight of difluoromethane (HFC-32); (b) 4.5%+/−0.5% by weight of pentafluoroethane (HFC-125); (c) 38%+/−0.5% by weight of 1,1,1,2-tetrafluoroethane (HFC-134a); and (d) 53%+/−0.5% by weight of HFO-1234ze(E). The refrigerant according to this paragraph is referred to herein for convenience as Refrigerant 9.

The present invention includes a multi-component refrigerant consisting of the following four components, with each compound being present in the following relative percentages: (a) 4.5%+/−0.5% by weight of difluoromethane (HFC-32); (b) 4.5%+/−0.5% by weight of pentafluoroethane (HFC-125); (c) 38%+/−0.5% by weight of 1,1,1,2-tetrafluoroethane (HFC-134a); and (d) 53%+/−0.5% by weight of HFO-1234ze(E). The refrigerant according to this paragraph is referred to herein for convenience as Refrigerant 10.

Refrigerants comprising at least about the % by weight, or which consist essentially of or consist of the four compounds indicated in the following table and wherein each compound is present in the following relative percentages is referred to herein as Refrigerants 11 to 15:

| | at least % by | | | | |
|---|---|---|---|---|---|
| | weight of the | HFC-32 | HFC-125 | HFC-134a | HFO-1234ze(E) |
| | following three | (% by | (% by | (% by | (% by |
| REFRIGERANT | compounds | weight) | weight) | weight) | weight) |
| Refrigerant 11 | 98.5 | 4.5 ± 0.3 | 4.5 ± 0.3 | 38 ± 0.3 | 53 ± 0.3 |
| Refrigerant 12 | 98.5 | 4.5 ± 0.3 | 4.5 ± 0.3 | 38 ± 0.5 | 53 ± 0.5 |
| Refrigerant 13 | 99.5 | 4.5 ± 0.3 | 4.5 ± 0.3 | 38 ± 0.3 | 53 ± 0.3 |
| Refrigerant 14 | 99.5 | 4.5 ± 0.3 | 4.5 ± 0.3 | 38 ± 0.5 | 53 ± 0.5 |
| Refrigerant 15 | Consisting of | 4.5 ± 0.3 | 4.5 ± 0.3 | 38 ± 0.5 | 53 ± 0.5 |

The present invention also includes methods of replacing HFC-134a in a MAC system or a low temperature refrigeration system or a medium temperature refrigeration system, said method comprising using in the system a refrigerant of the present invention, including each of Refrigerants 1-15, without changing the expansion device in such system.

The present invention also includes methods of replacing HFC-134a in a MAC system or a low temperature refrigeration system or a medium temperature refrigeration system and operating said system after said replacement, said method comprising: (a) using in the system a refrigerant of the present invention, including each of Refrigerants 1-15, without changing the expansion device in such system; and (2) operating the system. The method according to this paragraph is referred to herein for convenience as Method 1.

The present invention also includes methods of replacing HFC-134a in a MAC system or a low temperature refrigeration system or a medium temperature refrigeration system and operating said system after said replacement, said method comprising: (a) using in the system a refrigerant of the present invention, including each of Refrigerants 1-15, without changing the expansion device in such system; and (2) operating the system without changing the expansion device in such system and achieving a capacity that is at least 97% of the capacity of HFC-134a in the system and a COP that is at least 97% of the COP of HFC-134a in the system. The method according to this paragraph is referred to herein for convenience as Method 2.

The present invention also includes methods of retrofitting a MAC system or a low temperature refrigeration system or a medium temperature refrigeration system containing HFC-134a as an existing refrigerant comprising: (a) removing at least a substantial portion of said HFC-134a from said system; and (b) without changing the expansion device in said system, replacing said removed HFC-134a with a refrigerant of the present invention, including each of Refrigerants 1-15. The method according to this paragraph is referred to herein for convenience as Method 3.

The present invention also includes methods of retrofitting and operating a MAC system or a low temperature refrigeration system or a medium temperature refrigeration system containing HFC-134a as an existing refrigerant comprising: (a) removing at least a substantial portion of said HFC-134a from said system; (b) without changing the expansion device in said system, replacing said removed HFC-134a with a refrigerant of the present invention, including each of Refrigerants 1-15; and (c) operating said system without changing the expansion device in such system. The method according to this paragraph is referred to herein for convenience as Method 4.

The present invention also includes methods of retrofitting and operating a MAC system or a low temperature refrigeration system or a medium temperature refrigeration system containing HFC-134a as an existing refrigerant comprising: (a) removing at least a substantial portion of said HFC-134a from said system; (b) without changing the expansion device in said system, replacing said removed HFC-134a with a refrigerant of the present invention, including each of Refrigerants 1-15; and (c) operating said system without changing the expansion device in such system and achieving a capacity that is at least 97% of the capacity of HFC-134a in the system and a COP that is at least 97% of the COP of HFC-134a in the system. The method according to this paragraph is referred to herein for convenience as Method 5.

### DETAILED DESCRIPTION OF THE INVENTION

Applicants have found that the refrigerants of the present invention, including Refrigerants 1-15 as described herein, are capable of providing exceptionally advantageous properties and in particular non-flammability and excellent power consumption associated with any one of Refrigerants 1 to 15 of the present invention as a replacement for, or as a retrofit for HFC-134a in MAC applications.

Applicants have found that the refrigerants of the present invention, including Refrigerants 1-15 as described herein, are capable of providing exceptionally advantageous properties and in particular non-flammability and excellent power consumption associated with any one of Refrigerants 1 to 15 of the present invention as a replacement for, or as a retrofit for HFC-134a in low temperature refrigeration applications.

Applicants have found that the refrigerants of the present invention, including Refrigerants 1-15 as described herein, are capable of providing exceptionally advantageous properties and in particular non-flammability and excellent power consumption associated with any one of Refrigerants 1 to 15 of the present invention as a replacement for, or as a retrofit for HFC-134a in medium temperature refrigeration applications.

A particular advantage of Refrigerants 1-15 of the present invention in preferred compositions is that they are non-flammable, as defined hereinafter. Thus, it is a desire in the art to provide a refrigerant composition which can be used as a replacement for R-134a, especially in MAC applications, and which has excellent heat transfer properties in MAC applications, low environmental impact (including particularly low GWP and near zero ODP) chemical stability, low or no toxicity, and/or lubricant compatibility and which maintains non-flammability in use. This desirable advantage can be achieved by the Refrigerants 1-15 of the present invention.

For the purposes of this invention, the term “about” in relation to temperatures in degrees centigrade means that the stated temperature can vary by an amount of ±1° C. In preferred compositions, temperature specified as being about is preferably ±0.5° C. of the identified temperature.

The present invention includes heat transfer compositions that include a refrigerant of the present invention, including particularly any of Refrigerants 1-15, and preferably, the heat transfer compositions of the present invention comprise a refrigerant of the present invention in an amount of greater than 40% by weight of the heat transfer composition or greater than about 50% by weight of the heat transfer composition, or greater than 70% by weight of the heat transfer composition, or greater than 80% by weight of the heat transfer composition or greater than 90% by weight of the heat transfer composition. The heat transfer composition may consist essentially of or consist of a refrigerant according to the present invention, including any of Refrigerants 1-25.

Definitions: The term “capacity” is the amount of cooling provided, (generally reported herein in BTUs/hr), by the refrigerant in the refrigeration system. This is experimentally determined by multiplying the change in enthalpy in BTU/lb, of the refrigerant as it passes through the evaporator by the mass flow rate of the refrigerant in the applicable refrigeration system (eg., MAC system). The enthalpy can be determined from the measurement of the pressure and temperature of the refrigerant. The capacity of the refrigeration system relates to the ability to provide a level of cooling or heating at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The given time period used for GWP is 100 years. GWP provides a common measure, which allows analysts to add up emission estimates of different gases. See www.epa.gov. GWP as used herein includes the 100 year given time period.

The term “nonflammable” refers to compounds or compositions which are determined to be nonflammable as determined in accordance with ASTM standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016, which is incorporated herein by reference in its entirety (“Non-Flammability Test”). Flammability is defined as the ability of a composition to ignite and/or propagate a flame.

The term “Occupational Exposure Limit (OEL)” is determined in accordance with ASHRAE Standard 34-2016 Designation and Safety Classification of Refrigerants.

As the term is used herein, “replacement for” with respect to a particular heat transfer composition of the present invention and a particular existing refrigerant means the use of the indicated composition of the present invention in a heat transfer system that heretofore had been commonly used with that existing refrigerant. Replacement for applies to all of the air conditioning and refrigeration systems listed herein and includes a method of replacement for such a system.

The heat transfer compositions of the invention may include other components for the purpose of enhancing or providing certain functionality to the compositions. Such other components or additives may include one or more of stabilizers, lubricants, dyes, solubilizing agents, compatibilizers, antioxidants, corrosion inhibitors, extreme pressure additives, and anti wear additives.

Thus, in preferred embodiments, the present invention includes methods of the present invention, including each of Methods 1-5, and heat transfer compositions that include a refrigerant of the invention, including each of Refrigerants 1-15, and a lubricant, especially for methods and heat transfer compositions that are intended for use in vapor compression systems. When present, the lubricant is preferably present in the heat transfer compositions, including heat transfer composition used in each of the methods, including Methods 1-5, in amounts of from about 30 to about 50 percent by weight of the heat transfer composition, and in some case potentially in amount greater than about 50 percent and other cases in amounts as low as about 5 percent. Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils are have sufficient solubility with the refrigerant that is comprised of an iodocarbon, the combination of the iodocarbon and the hydrocarbon oil might more stable than other types of lubricant. Such combination may therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used, including for example polyether oils (PEs).

Furthermore, the present compositions may also include a compatibilizer, such as propane, for the purpose of aiding compatibility and/or solubility of the lubricant. Such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference.

Other additives not mentioned herein can also be included by those skilled in the art in view of the teachings contained herein without departing from the novel and basic features of the present invention.

As mentioned above, the present invention achieves exceptional advantage in connection with systems known as low temperature refrigeration systems. As used herein the term “low temperature refrigeration system” refers to vapor compression refrigeration systems which utilize one or more compressors and a condenser temperature of from about 35° C. to about 45° C. In preferred embodiments of such systems, the systems have an evaporator temperature of from about −40° C. and less than about −12° C., more preferably from about −35° C. to about −25° C., with an evaporator temperature preferably of about −32° C. Moreover, in preferred embodiments of such systems, the systems have a degree of superheat at evaporator outlet of from about 0° C. to about 10° C., with a degree of superheat at evaporator outlet preferably of from about 4° C. to about 6° C. Furthermore, in preferred embodiments of such systems, the systems have a degree of superheat in the suction line of from about 15° C. to about 25° C., with a degree of superheat in the suction line preferably of from about 20° C. to about 25° C.

Each of the heat transfer compositions described herein, including those heat transfer compositions comprising any one of Refrigerants 1-15, is particularly provided for use in medium temperature refrigeration systems (with an evaporator temperature in the range of about −12° C. to about 0° C., preferably about −8° C.).

Each of the heat transfer compositions described herein, including those heat transfer compositions comprising any one of Refrigerants 1-15, is particularly provided for use in mobile air conditioning systems (with an evaporator temperature in the range of about 0° C. to about 10° C., preferably about 5° C.).

The present invention provides also methods and systems which utilize the compositions of the present invention, including methods and systems for heat transfer and for retrofitting existing heat transfer systems. Preferred method aspects of the present invention relate to methods of providing relatively low temperature cooling, such as in low temperature refrigeration systems. Preferred method aspects of the present invention relate to methods of providing medium temperature cooling, such as in medium temperature refrigeration systems. Preferred method aspects of the present invention relate to methods of providing MAC, such as in automobile air conditioning (AAC).

Other preferred method aspects of the present invention provide methods of retrofitting an existing low temperature refrigeration system designed to contain and/or containing HFC-134a comprising introducing a composition of the present invention (including any one of Refrigerant 1-Refrigerant 15) into the system without substantial engineering modification of said existing refrigeration system.

As the term is used herein, “without substantial engineering modification” means without changing the substantive specification for and/or without substantial alteration of the construction of the condenser, the evaporator and/or the expansion device (such as expansion valve and/or capillary tube) of the system.

Other preferred method aspects of the present invention provide methods of retrofitting a MAC system designed to contain and/or containing HFC-134a comprising introducing a composition of the present invention (including any one of Refrigerant 1-Refrigerants 15) into the MAC system without substantial engineering modification of said existing MAC system.

Other preferred method aspects of the present invention provide methods of retrofitting a medium temperature refrigeration system designed to contain and/or containing HFC-134a comprising introducing a composition of the present invention (including any one of Refrigerants 1-Refrigerants 15) into the medium temperature refrigeration system without substantial engineering modification of said existing MAC system.

It will be appreciated that when the heat transfer composition is used as a low GWP replacement for HFC-134a, the heat transfer composition may consist essentially of a refrigerant of the invention, including each of Refrigerants 1-15. The invention thus encompasses the use of the refrigerant of the invention, including each of Refrigerants 1-15, as a low GWP replacement for HFC-134a.

It will be appreciated by the skilled person that when the heat transfer composition is provided for use in a method of retrofitting an existing heat transfer system as described above, the method preferably comprises removing at least a portion of the existing HFC-134a refrigerant from the system. Preferably, the method, including each of Methods 1-5, comprises removing at least about 5%, at least about 10%, at least about 25%, at least about 50%, or at least about 75% by weight of the HFC-134A from the system and introducing into the system a refrigerant composition of the invention, including each of Refrigerants 1-15.

In alternative embodiments, rather than partially draining or removing from the existing refrigerant from the existing system, the refrigerants of the present invention, including any one of Refrigerants 1-15, may be used to “top off” existing systems after a partial refrigerant leak. Many commercial systems, for example, have relatively high refrigerant leak rates which require routine addition of refrigerant over the life of the system. In one method of the present invention, including each of Methods 1-5, a refrigerant system is provided with less than the full or designed charge of refrigerant in the system, which, in preferred embodiments, occurs as a result of leakage of refrigerant from the system, and a refrigerant composition of the present invention is used to recharge the system, preferably during normal recharge maintenance. If the system leaked HFC-134a, for example, it would be recharged with a refrigerant of the present invention, preferably while substantially maintaining capacity of the system, maintaining or improving energy efficiency (lower electricity consumption which equates to lower operating cost for the users), and lowering the GWP of the refrigerant contained in the system (lowering environmental impact). In preferred embodiments, such a method including each of Methods 1-5, can be performed regardless of how much refrigerant has leaked and provides a simple (and low cost) way to reduce environmental impact associated with recharging of an existent system without deviating from the routine maintenance schedule of the system.

The compositions of the invention may be employed as a replacement in systems which are used, or are suitable for use with, or which are systems used for applications that HFC-134a refrigerant had been used in, including existing and new heat transfer systems.

The compositions of the present invention exhibit many of the desirable characteristics of HFC-134a but have a GWP that is substantially lower than that of HFC-134a while at the same time having operating characteristics i.e. capacity and/or efficiency (COP) that are substantially similar to or substantially match, and preferably are as high as or higher than HFC-134a in MAC systems, or low temperature systems, or medium temperature systems. As a result the compositions of the present invention are highly desirable replacements for HFC-134a in existing heat transfer systems without requiring any significant system modification, for example of the condenser, the evaporator, the capillary tube and/or the expansion valve. The refrigerants of the present invention, including each of Refrigerants 1-15, can therefore be used as a direct replacement for HFC-134a in heat transfer systems.

The composition of the invention preferably exhibit operating characteristics compared with HFC-134a in MAC systems, or low temperature, or medium temperature systems wherein the efficiency (COP) of the composition matches or exceeds that of HFC-134a in the respective system; and/or the capacity is greater than 90% of the capacity of HFC-134a in the MAC systems, or low temperature or medium temperature systems in which the refrigerant composition of the invention is to be used as a replacement for the HFC-134a.

In order to enhance the reliability of the heat transfer system, and in particular the compressor, it is preferred that the present refrigerants, including in particular Refrigerants 1-15, result in a power consumption that is not more than 10% greater than the power consumption of HFC-134a in that system, particularly for MAC systems, medium temperature systems or low temperature systems.

Thus, each of the refrigerants described herein, including particularly each of Refrigerants 1-15, and any of the heat transfer compositions as described herein can be used to replace HFC-134a in any air conditioning systems, including particularly MAC systems, preferably in such systems that operate with an evaporator temperature in the range of about 0° C. to about 10° C.

Thus, each of the refrigerants described herein, including particularly each of Refrigerants 1-15, and any of the heat transfer compositions as described herein can be used to replace HFC-134a in a refrigeration systems, including low temperature refrigeration systems, preferably in such systems that operate with an evaporator temperature in the range of about −12° C. to about −40° C.

Each of the heat transfer compositions described herein, including each of Refrigerants 1-15, is particularly provided to replace HFC-134a in medium temperature refrigeration systems, preferably in such systems that operate with an evaporator temperature in the range of about 0° C. to about −12° C.

The ability of the refrigerant compositions of this invention to match the operating conditions of HFC-134A in the preferred MAC, low temperature and medium temperature systems of the present invention is illustrated by examples which follow.

The preferred compositions of the present invention tend to exhibit many of the desirable characteristics of HFC-134a but have a GWP that is substantially lower than that of HFC-134a while at the same time having a capacity and/or efficiency that is substantially similar to or substantially matches, and preferably is as high as or higher than HFC-134a. In particular, applicants have recognized that certain preferred embodiments of the present compositions tend to exhibit relatively low global warming potentials (“GWPs”), preferably less than about 1000, more preferably less than about 750, and even more preferably not greater than about 700.

### EXAMPLES

### Example 1

The global warming potential (GWP) was determined for three exemplary refrigerant composition of the present invention (identified as compositions A1, A2 and A3) and presented in Table 1 below together with the GWP of HFC-134a and three compositions (C1, C2 and C3) outside the preferred range of the present invention.

TABLE 1
GWP of Refrigerant Compositions

| Component | A1 | A2 | A3 | | C1 | C2 | C3 |
|---|---|---|---|---|---|---|---|
| | Weight Percentage | | | | | | |
| R32 | 3 | 4.5 | 6 | | | 7.5 | 9 |
| R125 | 3 | 4.5 | 6 | | | 7.5 | 9 |
| R134a | 39 | 38 | 37 | 100 | 42 | 36 | 34 |
| R1234ze(E) | 55 | 53 | 51 | | 58 | 49 | 48 |
| | GWP | | | | | | |
| | 686 | 734 | 783 | 1300 | 604 | 831 | 865 |

### Example 2: Retrofit Performance in Medium Temperature System with Capillary Tube

A retrofit simulation is performed for a medium temperature refrigeration system operating with a refrigerant condensing temperature of about 46° C., which generally corresponds to an outdoor temperature of about 35° C. The degree of sub-cooling at the expansion device inlet, which in this example is a capillary tube, is set to 5.55° C. The capillary tube is designed for the use of HFC-134a in the system. The evaporating temperature is set to −7° C., which corresponds to an indoor ambient temperature of about 2° C. The degree of superheat at evaporator outlet is set to 3.5° C. The compressor efficiency is set to 60%. The temperature rise in the compressor suction line is assumed to be 5° C. The pressure drop in the connecting lines (suction and liquid lines) is considered negligible, and heat leakage through the compressor shell is also considered to be negligible.

The results of this simulation indicate that, based on thermodynamic properties and calculations, each of the refrigerant compositions A1, A2, A3, C1, C2 and C3 will have essentially the same efficiency, that is, 100% relative to HFC-134a in the system +/−1% or less.

A medium temperature refrigeration system as described in the preceding paragraph was operated substantially as indicated in the simulation, and the actual results are reported in Table 2 below for each of refrigerant compositions A1-A3 and C2-C5, together with the simulation results (which are reported as “thermodynamic”).

TABLE 2
Performance In Medium Temperature Capillary Tube System

| | Capacity (as % of | | Efficiency (as % of | |
|---|---|---|---|---|
| | R134a capacity) | | R134a capacity) | |
| Composition | Thermodynamic | Actual | Thermodynamic | Actual |
| R134a | 100% | 100% | 100% | 100% |
| A1 | 95% | 95% | 99% | 100% |
| A2 | 99% | 98% | 99% | 97% |
| A3 | 103% | 100% | 99% | 95% |
| C1 | 86% | 90% | 100% | 105% |
| C2 | 107% | 103% | 99% | 93% |
| C3 | 111% | 105% | 99% | 91% |

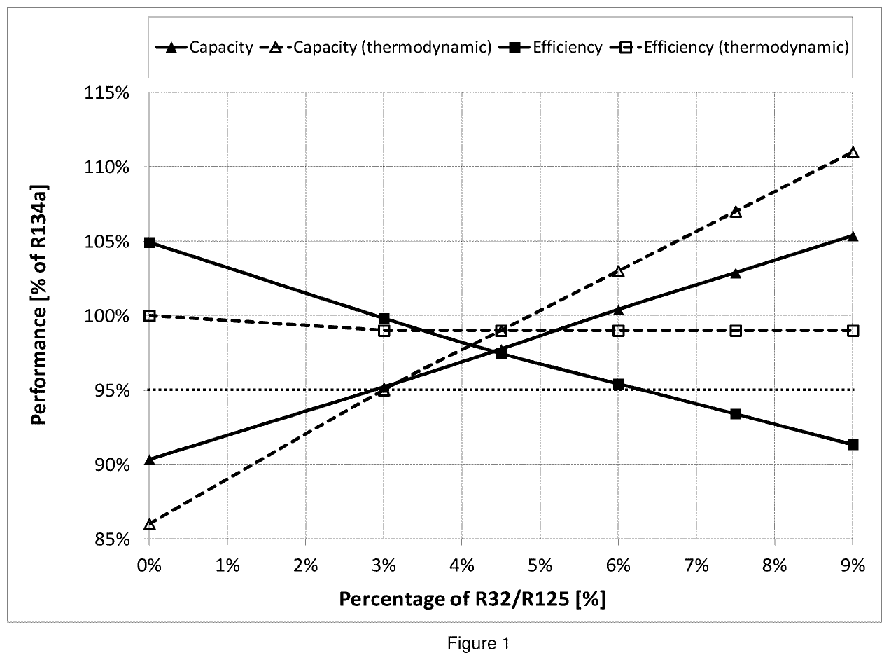

The results of the actual testing surprisingly indicate that efficiency is substantially lower than expected for compositions C2 and C3 (93% and 91%, respectively), and that accordingly the test work performed by applicants indicate that refrigerant compositions of the present invention (A1, A2 and A3) are each exhibit unexpectedly superior performance in terms of capacity (greater than 95%) and efficiency (greater than 95%) as drop-in retrofit replacements for HFC-134a in medium temperature refrigeration systems with capillary tube expansion systems. In contrast, each of refrigerants C1, C2 and C3, which are outside the preferred component range requirements of the present invention, show either a low capacity below 95% (see results for C1) or an efficiency less than 95% (see results for C2 and C3). Thus, only the refrigerant compositions of the present invention are able to at once achieve capacity of at least 95% and efficiency of at least 95% in medium temperature refrigeration systems with capillary tube expansion, which result is highly desirable and unexpected. These results are illustrated in FIG. 1 hereof.

### Example 3: Retrofit Performance in Medium Temperature System with TXV Expansion

The same system as described in Example 2 is simulated and actually operated, except that the expansion device used in the system is an expansion valve designed for use with R134a in the system was used for all the evaluations and no adjustments were carried out.

As with the capillary tube, the results of the simulation with the expansion valve indicate that, based on thermodynamic properties and calculations, each of the refrigerant compositions A1, A2, A3, C1, C2 and C3 will have essentially the same efficiency, that is, 100% relative to HFC-134a in the system +/−1% or less.

A medium temperature refrigeration system with the expansion valve as described in this example was operated substantially as indicated in Example 2, and the actual results are reported in Table 3 below for each of refrigerant compositions A1-A3 and C2-C5, together with the simulation results (which are reported as “thermodynamic”).

TABLE 3
Performance In Medium Temperature Expansion Valve System

| | Capacity (% R134a) | | Efficiency (% R134a) | |
|---|---|---|---|---|
| Composition | Thermodynamic | Actual | Thermodynamic | Actual |
| R134a | 100% | 100% | 100% | 100% |
| A1 | 95% | 95% | 99% | 100% |
| A2 | 99% | 98% | 99% | 98% |
| A3 | 103% | 100% | 99% | 96% |
| C1 | 86% | 90% | 100% | 105% |
| C2 | 107% | 102% | 99% | 93% |
| C3 | 111% | 105% | 99% | 91% |

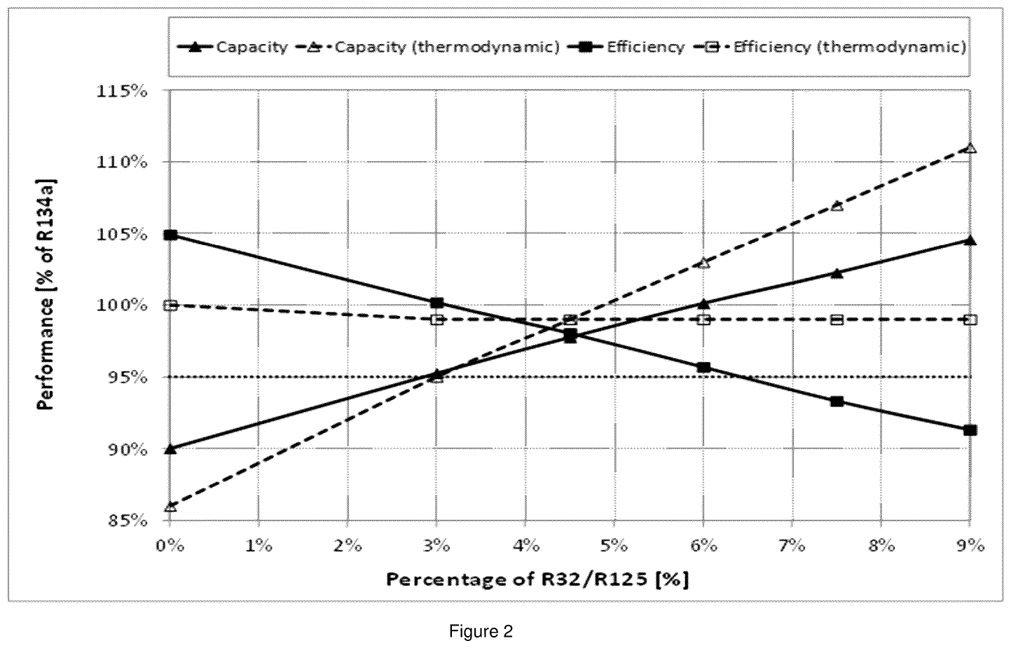

The results of the actual testing surprisingly indicate that efficiency is substantially lower than expected for compositions C2 and C3 (93% and 91%, respectively), and that accordingly the test work performed by applicants indicate that refrigerant compositions of the present invention (A1, A2 and A3) are each exhibit unexpectedly superior performance in terms of capacity (greater than 95%) and efficiency (greater than 95%) as drop-in retrofit replacements for HFC-134a in medium temperature refrigeration systems with expansion valve. In contrast, each of refrigerants C1, C2 and C3, which are outside the preferred component range requirements of the present invention, show either a low capacity below 95% (see results for C1) or an efficiency less than 95% (see results for C2 and C3). Thus, only the refrigerant compositions of the present invention are able to at once achieve capacity of at least 95% and efficiency of at least 95% in medium temperature refrigeration systems with expansion valve expansion, which result is highly desirable and unexpected. These results are illustrated in FIG. 2 hereof.

Based on the actual results reported in Examples 2 and 3, applicants evaluated the reliability of medium temperature systems which are retrofitted with refrigerants within the preferred ranges of the present invention (A1, A2 and A3) compared to compositions outside the preferred ranges (C1, C2 and C3). In particular, applicants have noted that if the compressor power consumption in a retrofit is about 10% or higher than the power consumption with R134a in the system, then the reliability of the compressor is likely to be negatively impacted. Based on such negative reliability impact, applicants have determined that refrigerants C2 and C23 have 10% or higher compressor power in a retrofit of R134a systems. In contrast, both power consumption and super heat for the retrofit systems using the present refrigerants (A1, A2 and A3) show unexpectedly higher levels of reliability, as shown in the Table 5 below.

TABLE 5
Reliability Parameters

| | Capillary Tube | | TXV | |
|---|---|---|---|---|
| | | Evaporator | | Evaporator |
| | Power | Superheat | Power | Superheat |
| Composition | (% R134a) | (° C.) | (% R134a) | (° C.) |
| R134a | 100% | 3.5 | 100% | 5.5 |
| A1 | 95% | 3.5 | 95% | 3.6 |
| A2 | 100% | 3.4 | 100% | 4.4 |
| A3 | 105% | 3.4 | 105% | 5.1 |
| C1 | 86% | 3.5 | 86% | 2.3 |
| C2 | 110% | 3.5 | 110% | 5.9 |
| C3 | 115% | 3.4 | 114% | 6.6 |

### Example 5: Performance Analysis in an Automobile Air Conditioning System

The compositions of the invention may be used in retrofitting an automobile air conditioning system. This example tests the standard cycle performance at conditions corresponding to M35 test condition for a mobile air conditioning system using exemplary compositions of the invention.

### Operating Conditions:

a. Condensing temperature=5000, Corresponding outdoor ambient temperature=35° C.
b. Condenser sub-cooling=10° C.
c. Evaporating temperature=4° C.
d. Evaporator Superheat=8° C.
e. Isentropic Efficiency=60%
f. Volumetric Efficiency=100%

TABLE 6
Performance in an automobile air conditioning
system (M35 test condition)

| Refrigerant | Capacity | Efficiency |
|---|---|---|
| R134a | 100% | 100% |
| A1 | 95% | 100% |
| A2 | 100% | 100% |
| A3 | 104% | 99% |
| C1 | 87% | 100% |
| C2 | 108% | 99% |
| C3 | 112% | 99% |

What is claimed is:

1. A method of retrofitting a heat transfer system containing HFC-134a as the refrigerant comprising:
removing at least a portion of said HFC-134a from said system;
introducing into said system a refrigerant comprising at least about 97.5% by weight of the following four components, with each compound being present in the following relative percentages:
(a) from 2% to about 7% by weight of difluoromethane (HFC-32);
(b) from 2% to about 7 by weight of pentafluoroethane (HFC-125);
(c) from about 35% to about 50% by weight of 1,1,1,2-tetrafluoroethane (HFC-134a); and
(d) from about 50% to about 55% by weight of trans-1,3,3,3-tetrafluoropropene (HFO-1234ze(E)).

2. The method of claim 1 wherein said system is a mobile air conditioning system.

3. The method of claim 1 wherein said system is a medium temperature refrigeration system.

4. The method of claim 1 wherein said system is a low temperature refrigeration system.

5. The method of claim 1 wherein said introduced refrigerant comprises at least about 98.5% of said four components.

6. The method of claim 1 wherein said introduced refrigerant comprises at least about 99.5% of said four components.

7. The method of claim 1 wherein said introduced refrigerant comprises the following four components, with each compound being present in the following relative percentages:
(a) from 2.5% to about 6.5% by weight of difluoromethane (HFC-32);
(b) from 2.5% to about 6.5 by weight of pentafluoroethane (HFC-125);
(c) from about 36% to 40% by weight of 1,1,1,2-tetrafluoroethane (HFC-134a); and
(d) from 51% to 55% by weight of trans-1,3,3,3-tetrafluoropropene (HFO-1234ze(E)).

8. The method claim 1 wherein said introduced refrigerant comprises the following four components, with each compound being present in the following relative percentages:
(a) from 3.5% to about 5.5% by weight of difluoromethane (HFC-32);
(b) from 3.5% to about 5.5 by weight of pentafluoroethane (HFC-125);
(c) from about 37% to 39% by weight of 1,1,1,2-tetrafluoroethane (HFC-134a); and
(d) from 52% to 54% by weight of trans-1,3,3,3-tetrafluoropropene (HFO-1234ze(E)).

9. The method claim 1 wherein said introduced refrigerant comprises the following four components, with each compound being present in the following relative percentages:
(a) 4.5%+/−0.5% by weight of difluoromethane (HFC-32);
(b) 4.5%+/−0.5% by weight of pentafluoroethane (HFC-125);
(c) 38%+/−0.5% by weight of 1,1,1,2-tetrafluoroethane (HFC-134a); and
(d) 53%+/−0.5% by weight of HFO-1234ze(E).

10. The method claim 1 wherein said introduced refrigerant comprises the following four components, with each compound being present in the following relative percentages:
(a) 4.5%+/−0.3% by weight of difluoromethane (HFC-32);
(b) 4.5%+/−0.3% by weight of pentafluoroethane (HFC-125);
(c) 38%+/−0.3% by weight of 1,1,1,2-tetrafluoroethane (HFC-134a); and
(d) 53%+/−0.3% by weight of HFO-1234ze(E).
